(19) United States
(12) Patent Application Publication
(10) Pub. No.: US 2010/0320360 A1
(43) Pub. Date: Dec. 23, 2010

(54) EQUIPMENT SUPPORT PLATFORM

(75) Inventor: Geoff McLeod, St. Petersburg, FL (US)

Correspondence Address: Maxey Law Offices, PLLC, 15500 Roosevelt Blvd., SUITE 305, CLEARWATER, FL, 33760, US

(73) Assignee: MESA MODULAR SYSTEMS, INC., ST. PETERSBURG, FL (US)

(21) Appl. No.: 12/766,291

(22) Filed: Apr. 23, 2010

Related U.S. Application Data
(60) Provisional application No. 61/218,105, filed on Jun. 18, 2009.

(51) Int. Cl. F16M 9/00

(52) U.S. Cl. 248/678; 248/680

(57) ABSTRACT

An earth anchored equipment support platform for supporting equipment at a desired elevation above the ground surface where the earth anchor is enclosed and concealed by the equipment support platform includes a top, a bottom and a sidewall joined with and formed along the perimeter of the top. An earth anchor receiving space is enclosed by the sidewall. A sight passage extends through the sidewall and into the earth anchor receiving space, wherein the earth anchor receiving space is viewable from an exterior position of the sidewall though the sight passage. Two or more equipment support platforms can be stacked, one on top of each other, in a partially nested arrangement to increase equipment elevation.

### CROSS-REFERENCE TO RELATED APPLICATIONS

This application claims the benefit of U.S. Provisional Application No. 61/218,105, filed Jun. 18, 2009, the entire of which is incorporated herein by reference.

### FIELD OF THE INVENTION

The present invention relates generally to pads for supporting and securing mechanical equipment located outside and more particularly, relating to an air conditioning unit support pad to support and elevate an air conditioning unit above the ground, and maintain the air conditioning unit in position when subjected to strong winds.

### BACKGROUND OF THE INVENTION

An exterior air conditioning unit is typically placed upon a support pad or other support structure to elevate the air conditioning unit above the ground surface, and to provide a substantially level support surface for operation of the air conditioning unit. Raising the air conditioning unit above the ground surface protects the air conditioning unit from damage due to local flooding and ground moisture. Traditionally, the support pad is either a site poured concrete pad or is a pre-fabricated concrete pad that is transported to the site. Site poured concrete pads are expensive, and pre-fabricated concrete pads and blocks are heavy and awkward to move, and are subject to breaking and cracking during transport. New building code requirements in some areas affected by severe weather conditions dictate that newly installed air conditioning units are to be securely strapped with tie-downs to prevent the air conditioning unit from be displaced during severe weather conditions by strong winds or flooding. Additionally, new building codes in some areas require the air conditioning unit to be elevated above the ground to be level with the lowest finished floor.

There has been development in providing support pads manufactured from lightweight material for easy transportation to an air conditioning site. However, they do not meet new building code requirements set in place to protect air conditioning units from the effects of severe storms. Additionally, they do not address the hazard of exposed tie-down straps, and they do not provide modular ability to elevate the air conditioning unit above the ground to meet new building code requirements. Accordingly, there is a need for a new air conditioning support platform that is lightweight for easy transportation and handling, and that meets tie-down and elevation building code requirements.

### SUMMARY OF THE INVENTION

The preferred embodiments of the present invention addresses this need by providing a support platform for an air conditioning unit that is constructed from a high strength and light weight material.

The preferred embodiments of the present invention also provide a support platform having an improved anchoring which conceals the anchor within the support platform, and thus removing hazards associated with exposed anchors, and also deters theft.

The preferred embodiments of the present invention also provide a support platform having an inspection port permitting viewing of a concealed anchor.

The preferred embodiments of the present invention also provide a support platform that is modular and permits stacking of multiple alike support platforms to achieve a desired above ground elevation of an air conditioning unit.

The preferred embodiments of the present invention also provide a support platform that is capable of supporting and securing an air conditioning unit to meet severe weather building code requirements.

The preferred embodiments of the present invention also provide a support platform that includes provisions for indicating to an installer the proper location to secure an air conditioning unit to the support platform using penetrating fasteners.

The preferred embodiments of the present invention also provide a support platform that is easy to manufacture.

The preferred embodiments of the present invention also provide a support platform that is easy to handle and install on site.

In general, in one aspect, an equipment support platform is provided. The equipment support platform includes a top, a bottom and a sidewall joined with and formed along the perimeter of the top. An earth anchor receiving space is enclosed by the sidewall. A sight passage extends through the sidewall and into the earth anchor receiving space, wherein the earth anchor receiving space is viewable from an exterior position of the sidewall though the sight passage.

In general, in another aspect, an equipment support platform is provided. The equipment support platform includes a generally flat top having top and bottom faces. A sidewall is joined along the perimeter of the top and extends therefrom and terminates at a bottom end. The sidewall defines and encloses an interior space. A plurality of vertically oriented interior support walls traverse the interior space in an intersecting pattern forming an internal support webbing. The support webbing define an earth anchor receiving space vertically extending within the interior space. A sight passage extends through the sidewall and the support webbing into the earth anchor receiving space, whereby the earth anchor receiving space is viewable exteriorly of the sidewall through the sight passage.

In general, in another aspect, an equipment support is provided. The equipment support includes a platform having a top, a bottom and a sidewall joined with and formed along the perimeter of the top. The platform further has a vertically extending earth anchor receiving space enclosed by the sidewall. A sight passage extends through the sidewall and into the earth anchor receiving space, wherein the earth anchor receiving space is viewable from an exterior position of the sidewall though the sight passage. The platform is positioned and supported on a ground surface. An earth anchor extends the earth anchor receiving space with one end of the earth anchor being inserted into the ground surface and secured against withdrawal therefrom, and an opposite end of the earth anchor secured to the platform, wherein the earth anchor is in tension drawing the platform against the ground surface and against movement relative to the ground surface.

In general, in yet another aspect, an equipment support is provided. The equipment support includes two or more platforms vertically stacked and supported on a ground surface. An earth anchor extends the two or more platforms with one end thereof inserted into the ground surface and secured against withdrawal therefrom, and the opposite end of the earth anchor secured to the top most platform of the two or more platforms. The earth anchor is in tension drawing the two or more platforms together and against the ground surface and against movement relative to the ground surface. Each of the two more platforms comprising a top, a bottom and a sidewall joined with and formed along the perimeter of the top, a vertically extending earth anchor receiving space enclose by the sidewall, and a sight passage extending through the sidewall and into the earth anchor receiving space. The earth anchor extends the two or more platforms within the earth anchor receiving space of each of the two or more platforms.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The accompanying drawings, which are included to provide further understanding of the invention and are incorporated in and constitute a part of this specification, illustrate preferred embodiments of the invention and together with the description serve to explain the principles of the invention, in which:

FIG. 1 is an elevation view of an equipment support platform constructed in accordance with the principles of the present invention in use and positioned on the ground surface and anchored thereto for supporting and securing the attached air conditioning unit;

FIG. 2 is a top view of an equipment support platform constructed in accordance with the principles of the present invention and an attached and secured air conditioning unit;

FIG. 3 is a top perspective of an equipment support platform constructed in accordance with the principles of the present invention;

FIG. 4 is a bottom perspective view of an equipment support platform constructed in accordance with the principles of the present invention;

FIG. 5 is an enlarged, partial cross-sectional elevation view illustrating a bearing strip exploded from the support platform;

FIG. 6 is a cross-sectional elevation view of an equipment support platform constructed in accordance with the principles of the present invention positioned and anchored to the ground, and supporting and securing an air conditioning unit attached thereto;

FIG. 7 is an elevation view of a support platform system including multiple support platforms stacked together in accordance with the principles of the present invention; and

FIG. 8 is an enlarged, partial cross-section view of two platforms stacked together.

### DETAILED DESCRIPTION OF THE INVENTION

Reference will now be made in detail to the preferred embodiments of the present invention, examples of which are illustrated in the accompanying drawings.

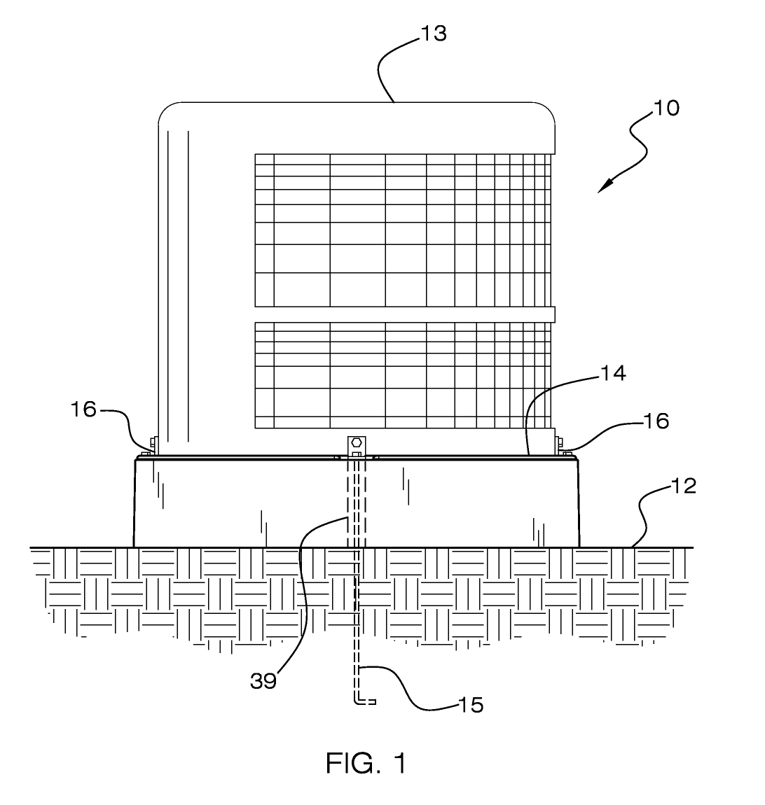

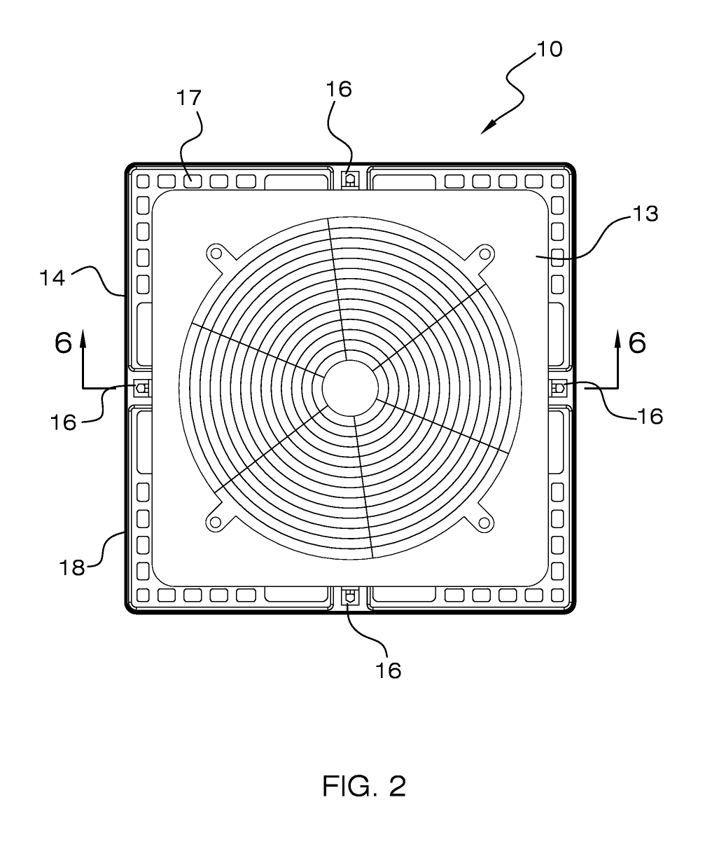

As illustrated in simplified, somewhat schematic form in FIGS. 1 and 2, in a representative embodiment thereof this invention provides a support platform 10 for use supporting an article of equipment, for example an air-conditioning or heat pump condensing unit at an elevated position above the ground surface 12. In FIG. 1, the support platform 10 is positioned on the ground surface 12 and is anchored in place by one or more earth anchors 15. As illustrated, earth anchor 15 is centrally located relative to the support platform and extends downwardly through the support platform, through the interior thereof, and into the underlying ground surface 12. In this manner, the earth anchor 15 is enclosed by the support platform and is concealed from view from the exterior of the support platform, thus not presenting a hazard to children, animals or lawn equipment.

An air conditioning unit 13 is positioned on top 14 of the support platform 10, and thus, is supported at an elevated distance above the ground 12 a distance equal to the height of the support platform. The air conditioning unit 13 is fastened to the support platform 10 by a plurality of fastener clips 16, one on each side, which are attached to both the support platform, for example, at the top 14 and the air conditioning unit by threaded fasteners as will be further described below. The attachment of the air conditioning unit 13 is further illustrated in FIG. 2, which is a top view of FIG. 1.

The support platform 10 can be constructed from a light weight high strength material including, but not limited to composites, plastic and structural foam. In a non-limiting example, a typical support platform 10 will be dimensioned to 40 inches in width, 40 inches in length, and 8 inches in height. As will be further described, several support platforms 10 can be stacked together to form a support system to raise an air conditioning unit a desired height above the ground.

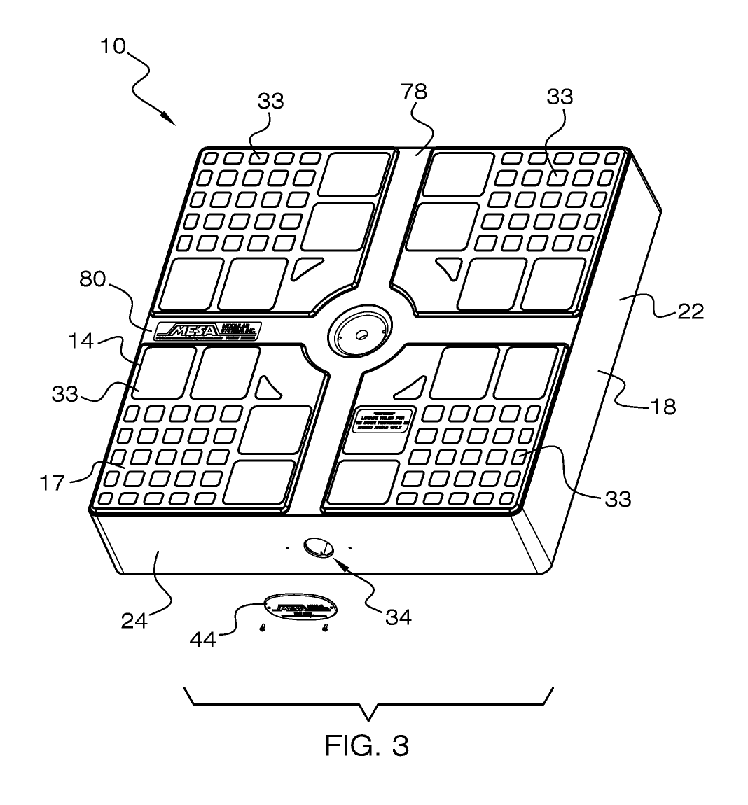

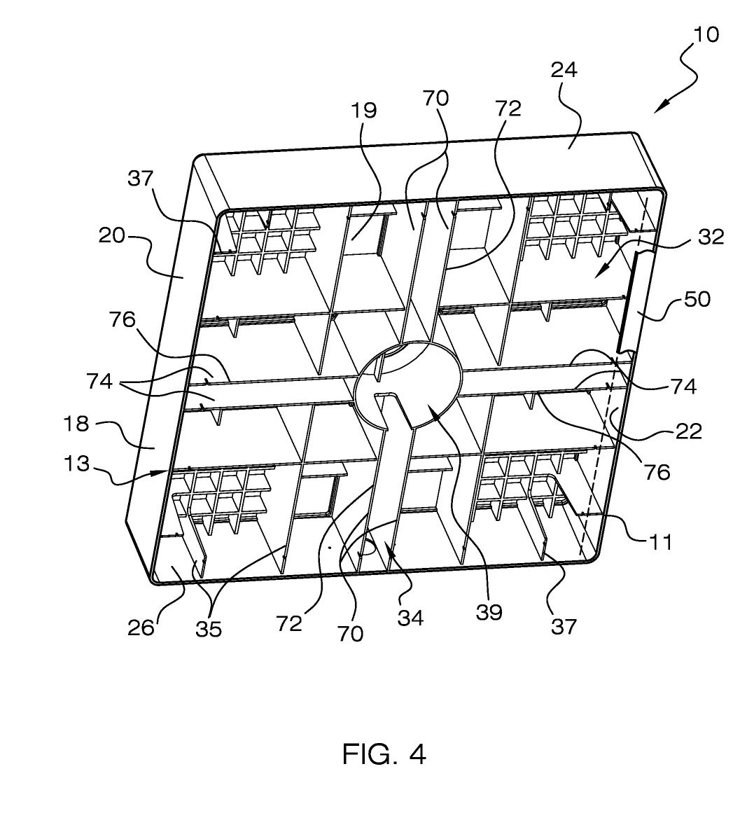

In FIGS. 3 and 4, there is shown a top perspective view and bottom perspective view, respectively, of the support platform 10. The support platform 10 is of a general rectangular shape, and includes a sidewall 18 having parallel sides 20 and 22, and parallel sides 24 and 26. Sidewall 18 is joined with generally flat top 14 along the perimeter thereof and extends therefrom terminating at edge 11. Sidewall 18 is slanted outwardly in a direction from the top to the bottom such that the bottom of the sidewall has a larger perimeter than the top of the sidewall, thus providing a wider base and increased load distribution.

The support platform 10 has an open bottom 13 that is generally defined by edge 11 of sidewall 18. A hollow interior space 34 is defined and enclosed by sidewall 18. A plurality of vertically oriented interior support walls 35 traverse the interior space 34 in an intersecting pattern forming an internal reinforcing or support webbing 32 of any suitable configuration. The interior support walls 35, forming webbing 32, are generally orthogonal with and joined to the bottom face 19 of the top 14. The platform 10 further includes an earth anchor receiving space 39 enclosed by sidewall 18. The earth anchor receiving space 39 can be centrally located with respect to the top 14. In an aspect, the configuration of reinforcing webbing 32 forms the earth anchor receiving space 39.

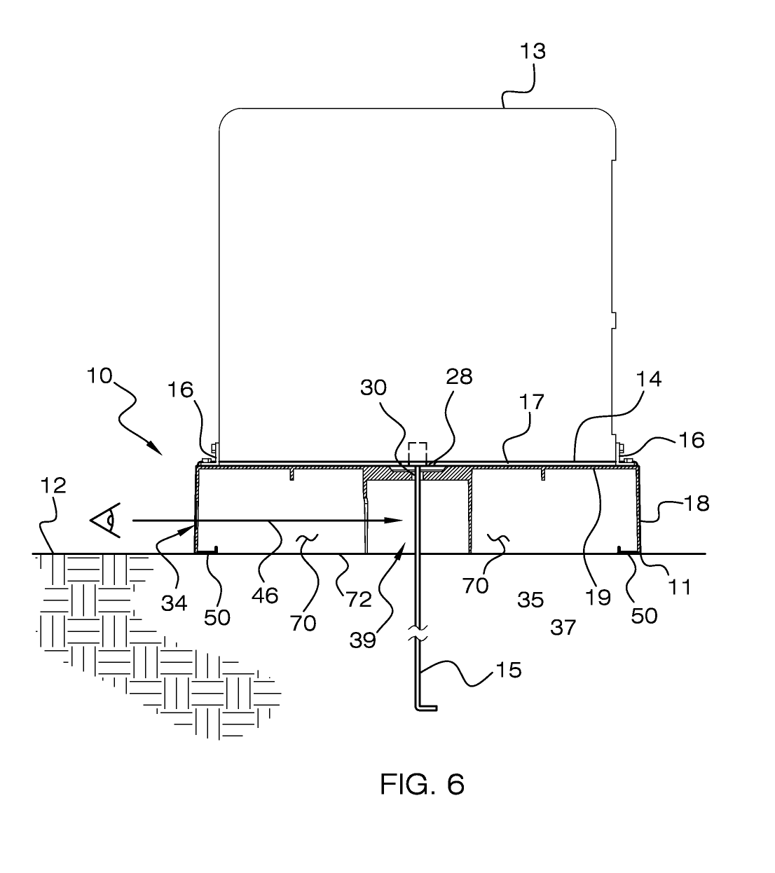

Still referring to FIGS. 3 and 4, the support platform 10 includes a sight passage 34 (best seen in FIG. 6) extending through sidewall 18 and into the earth anchor receiving space 39 along sight path 46. Sight passage 34 provides the ability to visually inspect an earth anchor 15 extending the earth anchor receiving space 39 of an installed support platform 10 from a position exteriorly of the support platform. A flashlight may be used to illuminate the interior of the support platform 10 by shining through the sight passage 34 to more clearly inspect the earth anchor 15. Plate 44 is removably attachable, for example by screws, to sidewall 18 to cover or close sight passage 34. Alternative, plate 44 can be attached to platform 10 by interference fit between the plate and the sight passage 34.

Referring to FIG. 3, top face 17 can include indicators 33, shown as repeating pattern, such as an area of a textured pattern, indicia or other markings which provide a visual indication of the correct attachment point for the fastener clips to the support platform 10.

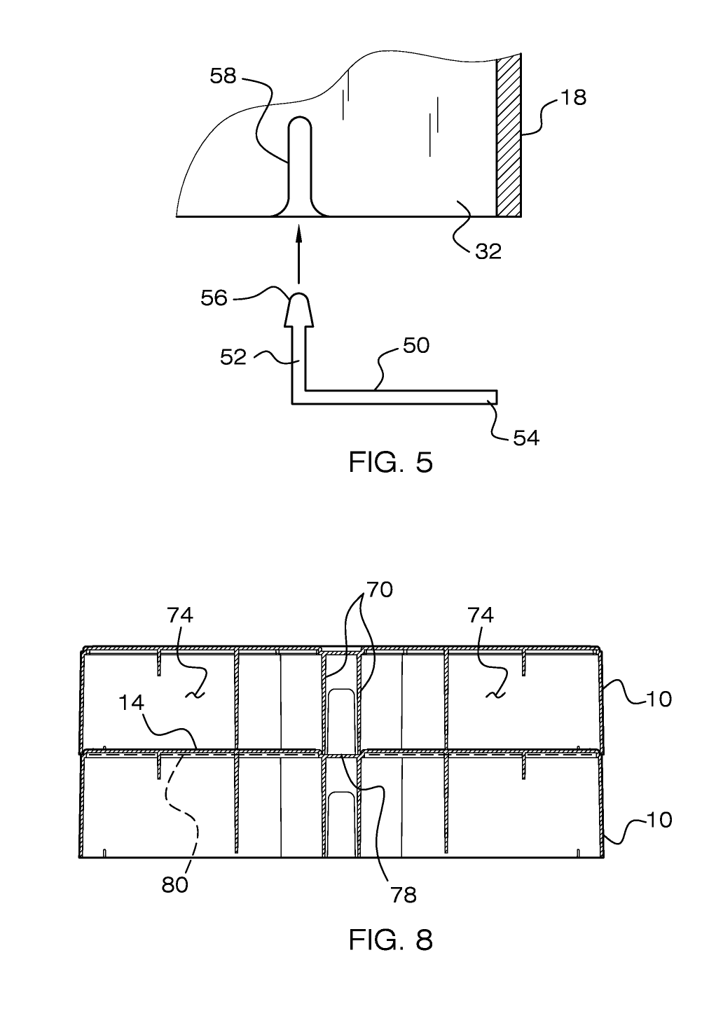

With reference to FIGS. 4 and 5, in an aspect, to increase the load bearing surface area provided by the sidewall 18 and webbing 32, platform 10 includes a plurality of L-shaped web strips 50 that are removably attached to webbing 32 along the interior perimeter of sidewall 18. Only a portion of a single web strip 50 is shown in FIG. 3 for clarity, the remaining portion of the single web strip is shown in broken line. Three additional strips would be positioned along the remaining interior perimeter of the sidewall. As mentioned, each web strip 50 is L-shaped having a short leg 52 and a long leg 54 joined with the short leg along the length of the strip. Short leg 52 includes a bulbous-shaped edge 56 that is frictionally received by slots 58 formed through the bottom edge of webbing 32 at an inwardly spaced distance from the interior surface of the sidewall 18 and generally perpendicular to the sidewall.

With reference to FIG. 6, there is shown an elevation cross-sectional view of the support platform 10 in use supporting equipment 13. As further can be seen here, top 14 is generally flat and includes top face 17 and bottom face 19. The equipment is positioned on top face 17 and secured to support platform 10 by clips 16. Support platform 10 is positioned on ground surface 12 and is secured thereto by earth anchor 15. The earth anchor 15 extends from a centrally located recess 28 formed in the support surface 17 downwardly through the earth anchor receiving space 39 of the support platform 10 and into the underlying ground 12. The centrally located recess 28 formed on the top face 17 accommodates and receives the head or top of the earth anchor 15 that is inserted through hole 30 centrally located within the recess so that the head of an earth anchor remains at least flush with or below the support surface so as not in interfere with an air conditioning unit positioned on the support surface.

The earth anchor 15 as shown comprises an elongated threaded rod to which is attached a toggle that can be driven into the ground. Upward tension on the threaded rod rotates the toggle into undisturbed ground, and thus preventing upward withdrawal of the earth anchor. The opposite end of the earth anchor 15 is threaded and is secured to the support platform, for example by a bolt and washer.

As can be seen, no portion of the earth anchor 15 from the support surface 17 downward is exposed to the exterior of the support platform 10. In this manner, the earth anchor 15 is not visible or generally accessible from the exterior of the support platform 10, and thus is concealed. The earth anchor 15 being concealed does not present safety hazards like exposed anchors, nor is it unsightly as exposed anchors are. As further can be seen, the earth anchor 15 can be viewed for inspection by looking along slight line 46 of the sight passage 34.

Still referring to FIG. 6, it can be further seen the increased load bearing support that is provided by web strips 50 between webbing 32 and the ground surface 12. The increased foot print provided by the web strips 50 prevents the support platform 10 from sinking into the ground surface.

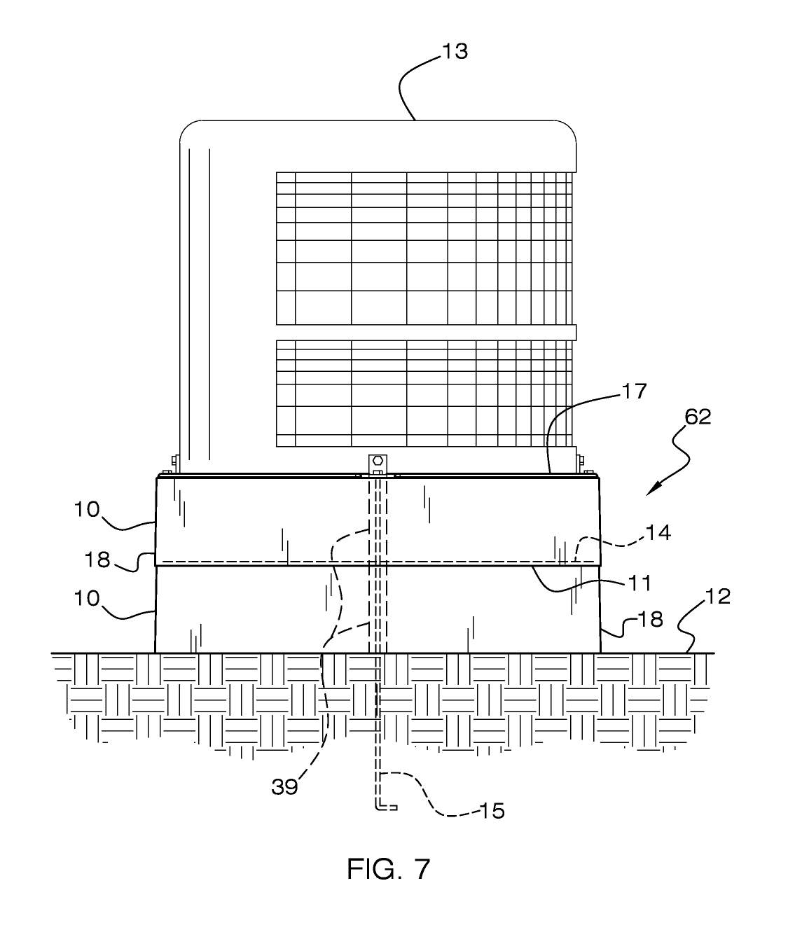

As mentioned above, two or more platforms 10 can be vertically stacked together to achieve a desired support elevation for equipment above the ground surface. As illustrated in simplified, somewhat schematic form in FIG. 7, there is shown a support platform system 62 including two support platforms 10 stacked together. As shown, the support platforms 10 are stacked in a partially nested arrangement with the top 14 of the lower platform being received through the bottom and within the sidewall 18 of the upper platform. In an aspect, at least a portion of the interior support walls 35 terminate at edge 37 at inwardly spaced distance from the terminal edge 11 of the sidewall 18 to permit the top of a platform to be received within an upper platform. Further, in this manner, the edge 37 of the interior support walls 35 of the upper platform can rest on top face 17 of the lower platform to further support the upper platform and distribute the weight of the upper platform and the equipment evenly across the lower platform. Equipment 13 is rested upon the top face 17 of the top 14 of the upper support platform 10, and is secured thereto clips 16. The earth anchor 15 extends downwardly from the upper support platform 10 through the anchor receiving spaces 39 of both support platforms and into the underlying ground surface. The earth anchor 15 is secured to the top platform 14, and when tightened, compresses the two support platforms together forming a single support platform structure that is securely anchored to the ground on which the air condition unit 13 is positioned and secured. Additional platforms can be stacked to further increase the elevation of the air conditioning unit 13 above the ground surface.

Referring back to FIGS. 3 and 4, in an aspect, the top 14 and the bottom 13 of the support platform can be configured such that when two or more platforms are stacked, the top of the lower platform and bottom of the upper platform engage in an interlock. In this manner, the interior support walls 35, forming the support webbing 36 can be configured to include a first pair of laterally spaced and longitudinally traversing walls 70 having a terminal edge 72 that is flush with edge 11 of sidewall 18, and a second pair of longitudinally spaced and laterally extend walls 74 having a terminal edge 76 that is flush with edge 11 of the sidewall. The first pair and the second pair of walls 70 and 74 may intersect forming a cross pattern. Edge 37 of the remaining interior support walls 35 are spaced at an inward distance from edge 11 of the sidewall 18. The top face 17 of the top includes corresponding longitudinally and laterally extending channels 78 and 80 respectively. The longitudinally and laterally extending channels 78 and 80 may intersect forming a correspond cross pattern. To this end, when a support platform 10 is stacked on top of a corresponding support platform, the first pair and the second pair of walls 70 and 74 of the top platform engage and register with the longitudinally and laterally extending channels 78 and 80 of the bottom support platform, thereby being interlocked, as shown in FIG. 8.

A number of embodiments of the present invention have been described. Nevertheless, it will be understood that various modifications may be made without departing from the spirit and scope of the invention.

1. An equipment support platform comprising:
a top, a bottom and a sidewall joined with and formed along the perimeter of said top;
an earth anchor receiving space enclosed by said sidewall; and
a sight passage extending through said sidewall and into said earth anchor receiving space, wherein said earth anchor receiving space is viewable from an exterior position of said sidewall though said sight passage.

2. The equipment support platform of claim 1, wherein said earth anchor receiving space extends vertically through said equipment support platform.

3. The equipment support platform of claim 1, wherein said sidewall slants outwardly in a direction from the top to the bottom of said sidewall.

4. The equipment support platform of claim 1, wherein said top and said bottom of are configured such that two or more bodies of said body are vertically stackable with the top of one equipment support platform being received interiorly of the sidewall of another equipment support platform.

5. The equipment support platform of claim 1, wherein said earth anchor receiving space is centrally located with respect to said top.

6. The equipment support platform of claim 1, wherein a top facing surface of said top includes indicators that indicates where one or more penetrating fasteners maybe caused to penetrate said top to secure equipment to said equipment support platform.

7. (canceled)

8. (canceled)

9. (canceled)

10. (canceled)

11. (canceled)

12. An equipment support comprising:
a platform having a top, a bottom and a sidewall joined with and formed along the perimeter of said top, said platform further having a vertically extending earth anchor receiving space enclosed by said sidewall, said platform further having a sight passage extending through said sidewall and into said earth anchor receiving space, wherein said earth anchor receiving space is viewable from an exterior position of said sidewall though said sight passage;
said platform being positioned and supported on a ground surface;
an earth anchor extending said earth anchor receiving space, one end of said earth anchor being inserted into said ground surface and secured against withdrawal therefrom, an opposite end of said earth anchor secured to platform, wherein said earth anchor is in tension drawing said platform against said ground surface and against movement relative to said ground surface.

13. The equipment support of claim 12, wherein said sidewall defines and encloses an interior space;
said platform further having a plurality of vertically oriented interior support walls traversing said interior space in an intersecting pattern forming an internal support webbing;
said support webbing defining said earth anchor receiving space; and
said sight passage further extends said support webbing into said earth anchor receiving space.

14. The equipment support of claim 12, wherein said sidewall slants outwardly in a direction from the top to the bottom of said sidewall.

15. The equipment support of claim 12, wherein said top face of said top includes indicators that indicates where one or more penetrating fasteners maybe caused to penetrate said top to secure equipment to said platform.

16. An equipment support comprising:
two or more platforms vertically stacked and supported on a ground surface;
an earth anchor extending said two or more platforms with one end thereof inserted into said ground surface and secured against withdrawal therefrom, and the opposite end of said earth anchor secured to the top most platform of said two or more platforms, said earth anchor in tension drawing said two or more platforms together and against said ground surface and against movement relative to said ground surface;
each of said two more platforms comprising a top, a bottom and a sidewall joined with and formed along the perimeter of said top, a vertically extending earth anchor receiving space enclosed by said sidewall, and a sight passage extending through said sidewall and into said earth anchor receiving space; and
wherein said earth anchor extends said two or more platforms within said earth anchor receiving space of each of said two or more platforms.

17. The equipment support of claim 16, wherein each of said two or more platforms: said sidewall defines and encloses an interior space;
said body further comprising a plurality of vertically oriented interior support walls traversing said interior space in an intersecting pattern forming an internal support webbing;
said support webbing defining said earth anchor receiving space; and
said sight passage further extends said support webbing into said earth anchor receiving space.

18. The equipment support of claim 17, wherein said sidewall of each of said two or more platforms slants outwardly in a direction from the top to the bottom of said sidewall.

19. The equipment support of claim 18, wherein said one or more platforms are stacked in a partially nested arrangement.
